(19) United States
(12) Patent Application Publication
(10) Pub. No.: US 2003/0135599 A1
(43) Pub. Date: Jul. 17, 2003

(54) Method and system for providing a telecommuting program

(76) Inventor: John F. Sanger, St. Paul, MN (US)

Correspondence Address: Michael A. Kondzella, 10650 County Road 81, Suite 112, Maple Grove, MN, 55369, US

(21) Appl. No.: 10/256,532

(22) Filed: Sep. 27, 2002

Related U.S. Application Data
(60) Provisional application No. 60/325,911, filed on Sep. 28, 2001.
(60) Provisional application No. 60/353,023, filed on Jan. 30, 2002.

(51) Int. Cl. G06F 15/173

(52) U.S. Cl. 709/223

(57) ABSTRACT

A regional telecommuting assessment project, designed to assess telework potential within a metropolitan service area, consists of a telework assessment, a community audit, a community visioning process, and implementation strategies. A telework deployment program, designed to assess telework potential within a business, consists of a telework assessment and profiling process, a mitigation assessment, scenario assessment modeling, policy review and development, a telework implementation plan, and a monitoring and refinement process. Both the regional and the business telework assessments are carried out by means of client interactivity with a system provider's website.

### FIELD OF THE INVENTION

This invention relates to telecommuting. In one of its more particular aspects, this invention relates to telework assessment deployment programs and in another of its more particular aspects, this invention relates to a method and system for assessing the telework potential within a region. In another of its more particular aspects, this invention relates to a method and system for providing a telecommuting program.

### BACKGROUND OF THE INVENTION

For the first time in human history, the Industrial Revolution required the vast majority of workers to leave their homes and travel to work. Now, two hundred years later, technology allows mankind to return to the home to conduct their work. This cultural adaptation challenges contemporary managers to understand how to operate with a distributed work force. It challenges workers to rely upon their community rather than the workplace for their social requirements. To address these strong emotional predispositions, a telework deployment program has been developed to demonstrate the economic and competitive advantages that telecommuting and telework can bring to the employer. It has been developed to encourage telework in response to other, broader social issues. These issues include at least the following:

1. Economic Competitiveness: It has been estimated that substantial savings, for example, as much as tens of thousands of dollars per deployed worker, can be realized. The economic benefits are obvious.

2. Energy and Environment: With less commuting by workers and fewer square feet required to house them, significant reductions in automobile emissions and savings in energy costs are possible.

3. Road Congestion: Every major urban area is now experiencing road congestion. Roads are expensive and transit does not serve every work site. Telework can mitigate the problem.

4. Family Balance: Away from the home for 10+ hours per day, parents are separated from their children, incur the high costs of day care, and return home from work with high levels of stress.

5. Work Force Development: Working from home makes a more productive and reliable work force, as workers must become more technologically competent, more independent, and more self-reliant.

6. Community Development: Once the link between the residential and employment locations has been weakened, the opportunity for workers to live anywhere becomes a real possibility. Rural and urban areas can become better balanced and more viable with less reliance upon government subsidies.

### SUMMARY OF THE INVENTION

The present invention is directed to methods and processes that collectively support the strategic deployment of telecommuting, and specifically telework. At the community level, the Regional Telecommuting Assessment Project (RTAP) assesses the telework potential within a region. At the employer level, the Telework Deployment Program (TDP) builds the business case for a Telework deployment and provides all of the tools necessary to adopt a plan that optimizes the business objective.

The RTAP is designed to assess the telecommuting potential of a Metropolitan Service Area (MSA). It consists of four phases:

1. telework assessment;

2. community telecommuting audit;

3. community visioning process;

4. telecommuting implementation strategies.

The TDP is designed for employers that wish to adopt a telework strategy as part of their business plan. The method generally includes the following phases:

1. telework assessment and profiling process;

2. mitigation assessment;

3. scenario assessment modeling;

4. policy review and development;

5. telework implementation plan; and

6. monitoring and refinement process.

The methods utilize data processing systems driven by main menus including interactive databases consisting of tables, forms, inquiries, and help screens.

The invention will be described in detail with reference to the drawings, which illustrate preferred embodiments of the present invention.

### BRIEF DESCRIPTION OF THE DRAWINGS

FIG. 1 is a schematic overview of the telework deployment program (TDP) of the present invention;

FIG. 1a is a more detailed block diagram of the TDP of FIG. 1;

FIG. 2 is a depiction of a main menu screen of the TDP;

FIG. 3 is a block diagram of the telework assessment and profiling process phase of the TDP of the present invention;

FIG. 4 is a block diagram of the mitigation assessment phase;

FIG. 5 is a block diagram of the scenario assessment modeling phase;

FIG. 6 is a block diagram of the policy review and development phase;

FIG. 7 is a block diagram of the telework implementation plan phase;

FIG. 8 is a block diagram of the monitoring and refinement process phase;

FIG. 9 is a depiction of a scenario modeling screen;

FIG. 10 is a diagrammatic view of an e-Consensus Forum;

FIG. 11 is a schematic overview of the regional telecommuting assessment project (RTAP) of the present invention; and

FIG. 12 is a more detailed block diagram of the RTAP of FIG. 11.

FIG. 13 is a diagram showing the interactivity of the system provider's website and the RTAP and TDP programs.

### DESCRIPTION OF PREFERRED EMBODIMENTS

### TDP

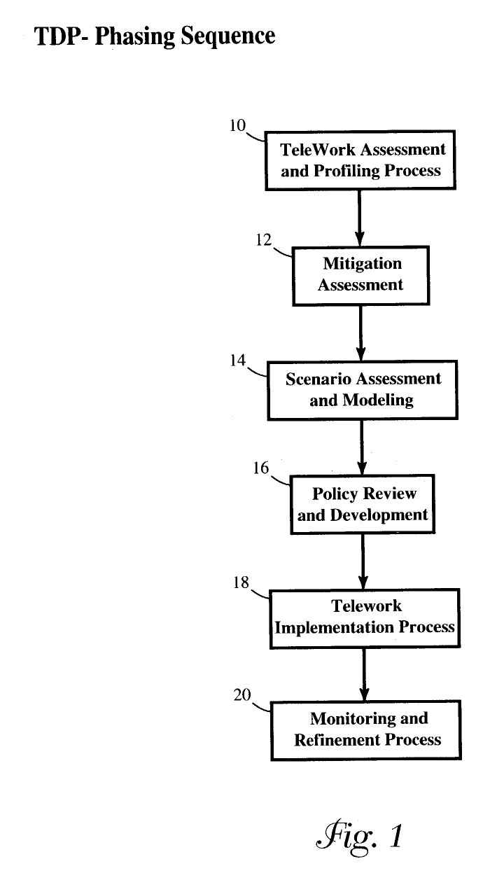

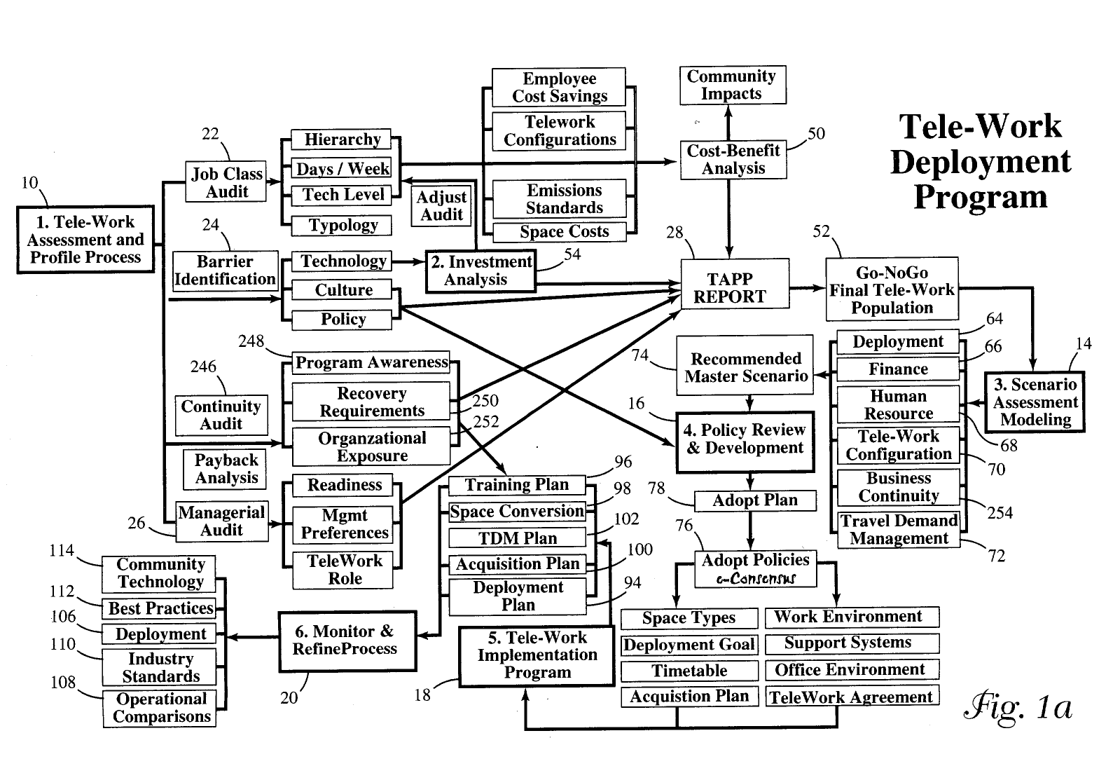

Referring now to the drawings, FIG. 1 shows the phases comprising the Telework Deployment Program (TDP) of the present invention. As shown in FIG. 1, the results of a Telework Assessment and Profiling Process (TAPP) 10 are subjected to Mitigation Assessment 12, the results of which are utilized in Scenario Assessment Modeling 14. The resulting scenario, following Policy Review and Development 16, is utilized in Telework Implementation Plan 18. Finally, Monitoring and Refinement Process 20 is applied. A more detailed Telework Deployment Program (TDP) is shown in FIG. 1a.

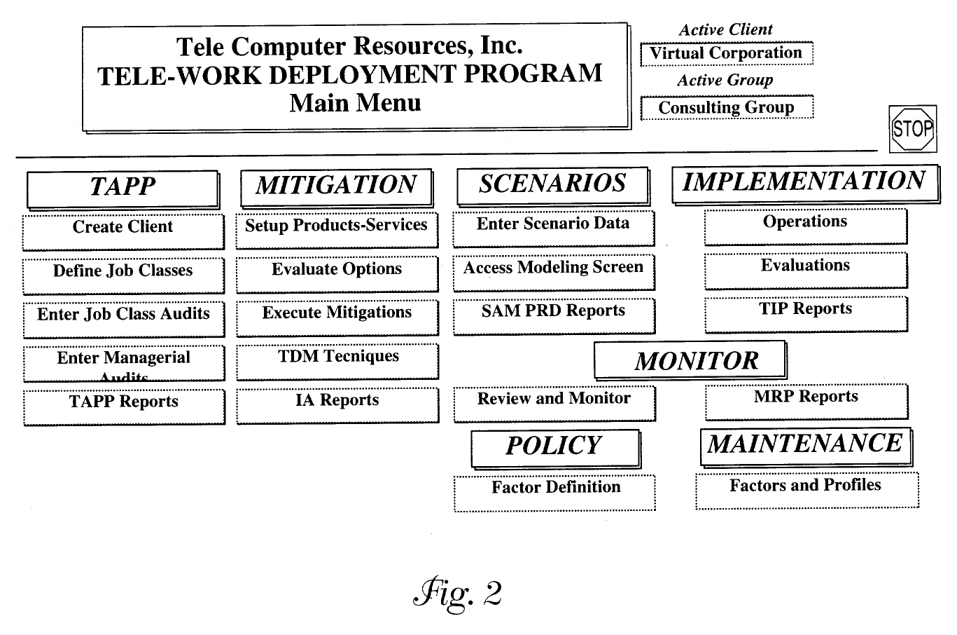

FIG. 2 depicts the main menu of the Telework Deployment Program(TDP) of the present invention. Typically, the menu is displayed on the screen of a computer monitor, permitting any of various choices to be selected by the client user.

### Telework Assessment and Profiling Process (TAPP)

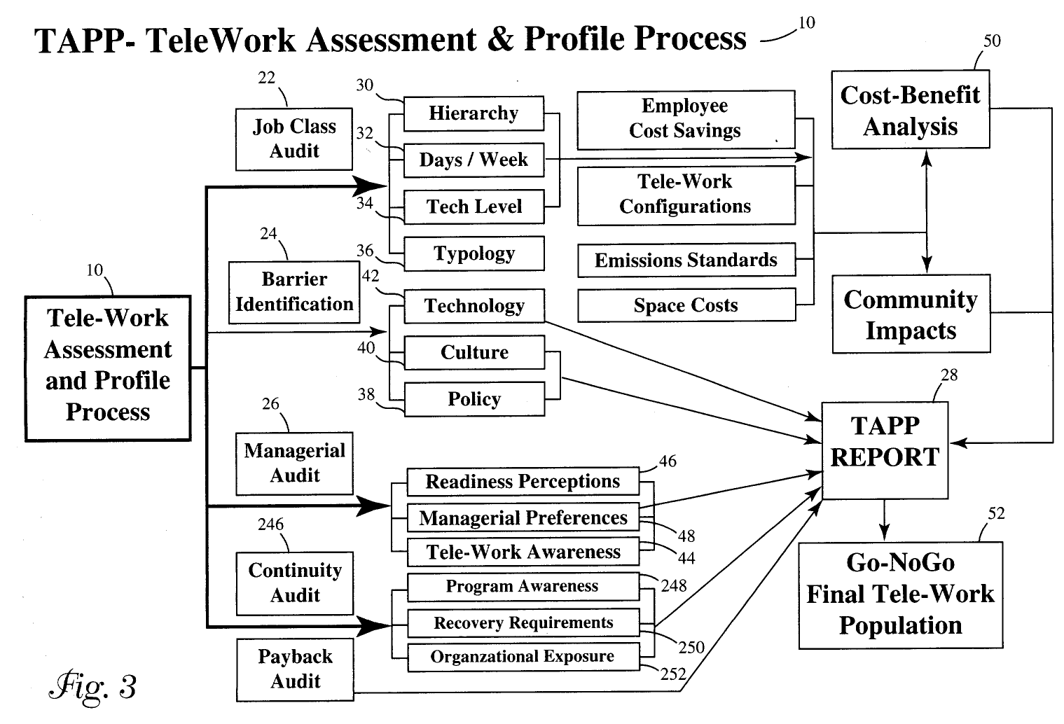

The Telework Assessment and Profiling Process phase (TAPP) 10 is shown in FIG. 3. The object of the TAPP is to define, based upon a norm, whether a telework deployment would be cost effective. The TAPP determines the maximum number of potential teleworkers within an organization and demonstrates the impact that deployment of this number of teleworkers would have on the organization's bottom line. It consists of a job class audit 22, barrier identification 24, and a managerial audit 26, which are used to prepare a report (the TAPP report 28).

A client record is established to provide a link to unite each group defined by the client. The divisions of the organization, separate buildings, or a multi-building campus could define a group.

A client group record is established with encoders for various categories, including NACIS, organizational class, community type, industry classification, geographic scope, telecommuting goals, employee cost-savings data, transit cost data, and travel demand. These encoders support a statistical research system.

In defining the job classes each unique job function is profiled. The job functions are linked to the Standard Occupational Classification System and to a jobs “hierarchy” 30. The jobs hierarchy is defined based upon function and position within the organization. Other information utilized includes the following: the number of individuals employed in the job class, the number of individuals already deployed, the average salary for this job class, the cost of training and recruitment for each employee, the annual turnover rate and absenteeism levels, the annual rate of employment growth, and the type of space in which the work is done.

The job class audit 22 is conducted with representatives of all job classes, using a system of scoring and weighting to define factors relating to the deployment of teleworkers. These factors include the number of days per week 32 that the worker could work remotely; the technology level 34 required to support the remote worker; and “worker typology” 36, which classifies the workers into site, discretionary, task, or mobile worker types.

Optionally, the TAPP client may elect to conduct a Business Continuity Assessment 246. Each representative identifies all of the functions that are performed in this occupation and a) provides a brief description of the function, b) identifies the lowest working environment possible to support the restoration of that function (from work at home to the traditional office environment), c) the period of time beyond which the function's lack of performance will significantly and adversely affect the client's operation; and, d) the level of their awareness about the existence and status of any restoration plan.

Barrier identification 24 identifies specific barriers to telework deployment, which may be policy barriers 38, cultural barriers 40, or technological barriers 42.

The managerial audit 26 involves all job classes. The purpose of the managerial audit is to determine the position of the staff with respect to their attitude towards telework (telework awareness 44), their perception of how ready key groups within the organization are to support a telework deployment (readiness perception 46), and their view of the relevance of telework to themselves, their employer, and the community at large (managerial preferences 48).

Based upon the inputs discussed above, the TAPP report 28 is prepared. The TAPP report documents the profile of the employer's workforce with respect to hierarchy, days per week, technology levels, and worker typology. It also identifies the telework barriers existent within the organization and how many classes of employees are impacted by each. In addition, the TAPP report calculates the fiscal impact of deploying different percentages of the potential workforce (cost-benefit analysis 50). These calculations include space conversions, equipment acquisition, support service requirements, communication requirements, and furniture requirements. The TAPP report provides a Go-No Go Final Telework Population 52.

### Mitigation Assessment (MA)

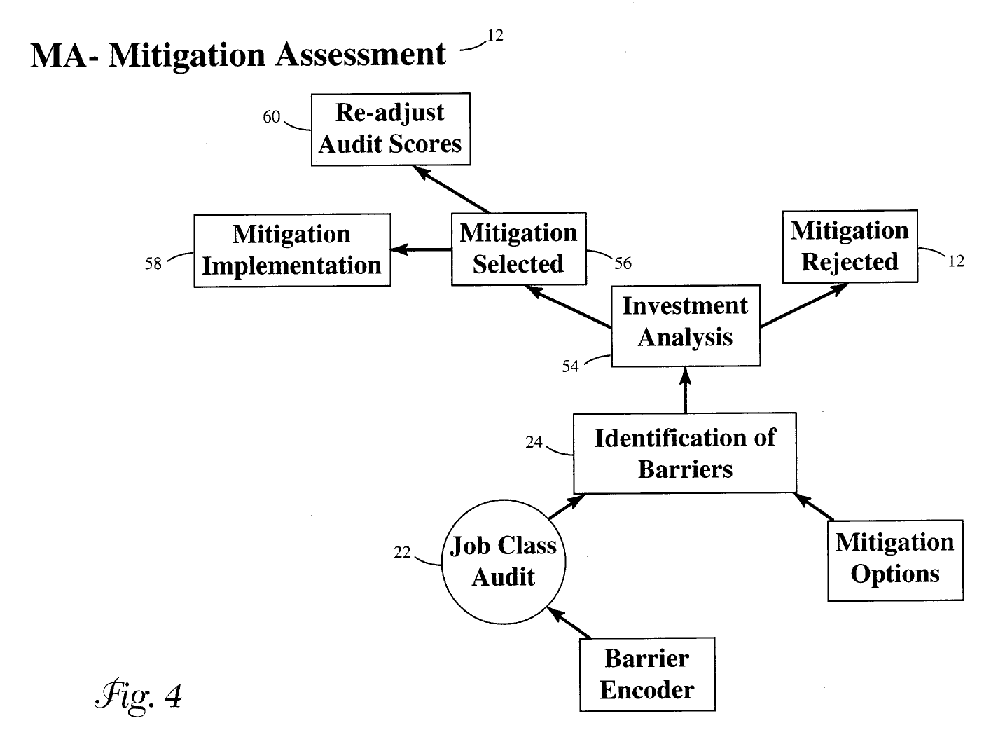

The Mitigation Assessment (MA) phase 12 is shown in FIG. 4. In this phase the client user is provided the opportunity to expand the number of potential teleworkers by performing cost-benefit evaluations (investment analysis 54) on each of the barriers identified in the job class audit to determine which mitigations may be appropriate (mitigation selected 56). The selected mitigations are then implemented (mitigation implementation 58) and the audit is recalculated to expand the number of teleworkers based upon the mitigation of specific barriers (re-adjust audit score 60). Not only does the Mitigation Assessment process examine specific technologies, but also the potential impact that a change in policy could have in the deployment process.

### Scenario Assessment Modeling (SAM)

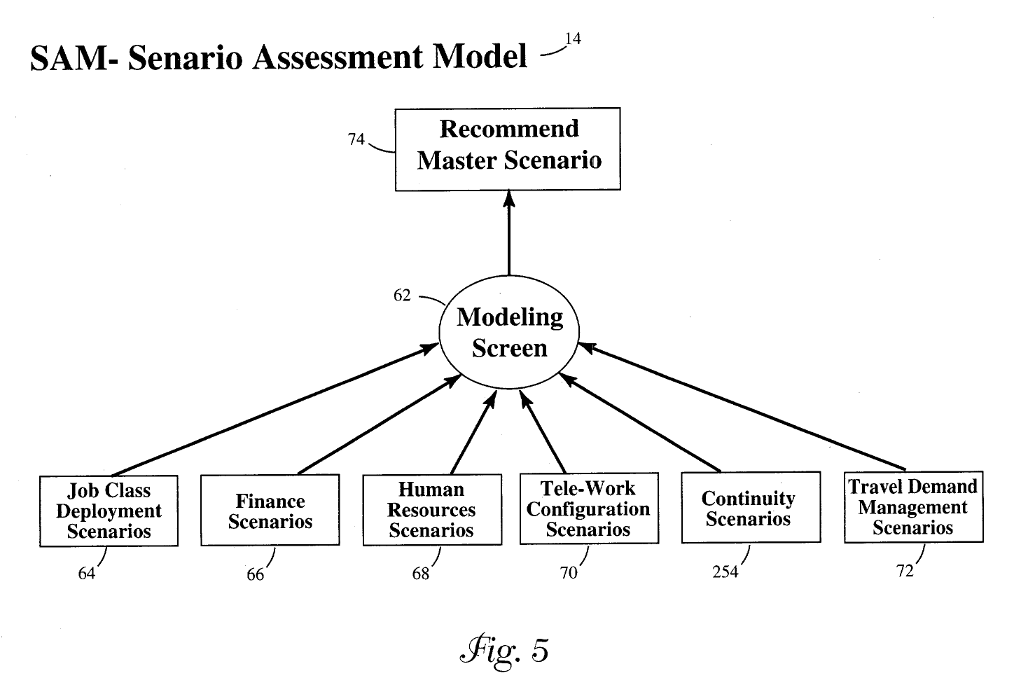

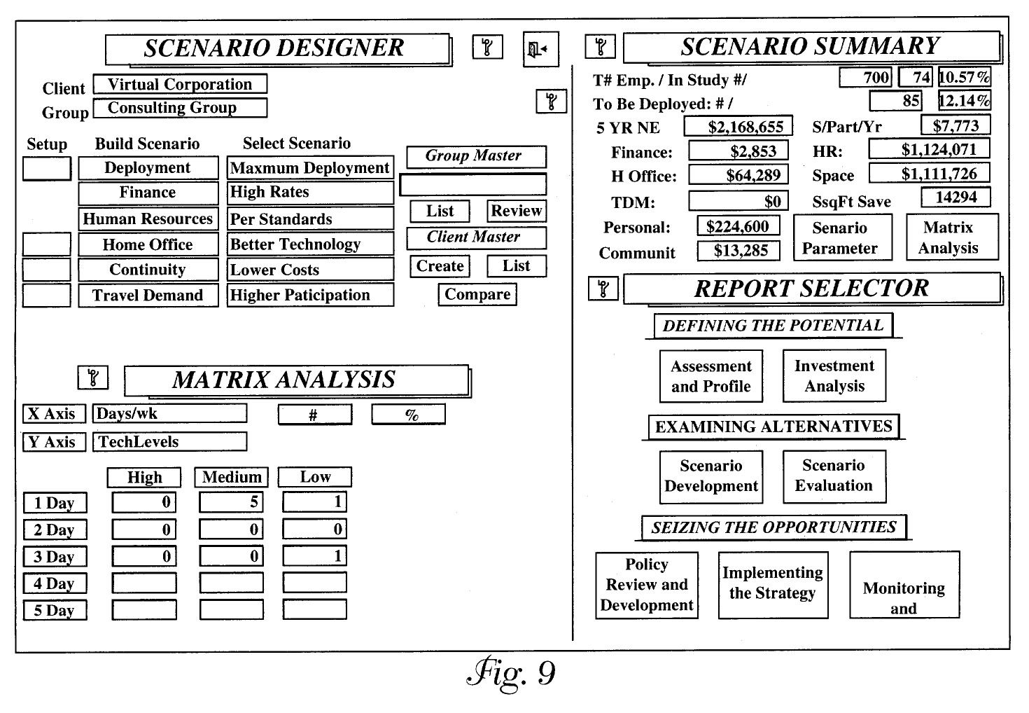

The Scenario Assessment Modeling phase 14 is shown in FIG. 5 and a Scenario Modeling Screen 62 is shown in FIG. 9. In order for the client user to develop alternative scenarios, the client is provided with software for developing databases in addition to those containing data from the steps described above. These databases relate to space types, product profiles, telework configurations, and travel demand techniques, for example. Each of these databases will be described in detail below.

The space type database supports spatial redesign and costing calculations. By understanding the profile of the space that an employee currently occupies and the profile of the space type that will be used when the employee comes into the office on a reduced number of days, a variety of calculations are possible. The profiled data include, for example, square feet per work space, square feet of common space per work space, cost per square foot, construction cost per square foot, tear down cost per square foot, and recovery period.

The product profile database is developed at two levels. First, profiles of basic products and services that are used in the telework configuration described below are provided. Second, those strategic products that are used in the Mitigation Assessment process previously described are provided. These product profiles include vendor, manufacturer, pricing information, shipping information, and specifications, which may include graphic or video images.

The telework configuration database is set up using the product profiles, from which the client constructs a unique set of products and services to support each worker configuration. A worker configuration is that set of products and services provided to each worker who has the same hierarchy and technology level and can perform telework the same number of days per week. Each of the products or services belongs to one of the following component groups: technology systems, technology peripherals, furniture, communications or services.

The travel demand technique database recognizes the important contributions that telework can make in relieving road congestion and reducing vehicular emissions. The database contains data relating to cost of the travel demand management technique, employer-community cost sharing, tracking the sponsoring agency, cost of implementation, and seasonal use factors.

A Continuity Configuration is developed similarly in that any additional products or services necessary to support an individual tasked with the additional responsibility for continuity planning is developed. Various Continuity Configurations are developed to match the various tasks required.

Utilizing these databases and the previously obtained data, scenarios are developed in several areas to build group scenarios that collectively allow an evaluation of the costs of a typical deployment plan, for example, a five year deployment plan. A group scenario consists of one scenario from each scenario area. Calculations are then made based upon a given set of scenarios and the results are stored on disk. When a number of group scenarios have been developed, their results can be compared to one another and evaluated against the business objectives to determine the optimal scenario. A master scenario can also be developed. The master scenario selects the optimal group scenario from each business unit and calculates the overall impact on the organization as a whole.

A typical six-area scenario scheme would include job class deployment 64, finance 66, human resources 68, telework configuration 70, continuity configuration 254, and travel demand management 72 scenarios.

Job class deployment is based upon hierarchy, days per week, and technology level. This scenario involves determining how many employees will be deployed in each of the next five years for each job class, calculating how many employees, factoring in job growth, are available to be deployed, and determining the space type that the employees will use when they return to the office or other workplace on non-telecommute days.

Finance determines, for each client group, amortization levels and rates and lease levels and rates.

Human resources determines, for each client group, productivity gains, absenteeism rate reductions, turn-over rate reductions, and the percentage of the soft dollar savings, which should be included in the cost-benefit calculations.

Telework configuration selects the desired products and services required to support each telework configuration, based upon hierarchy, days per week, and technology level.

Continuity configuration selects the desired products and services required to support the necessary recovery activities.

Travel demand management converts the deployment scenario into trips and estimates how many employees will use each of the available techniques, based upon hierarchy and days per week.

After the desired number of scenarios has been developed in each of the five areas, the user is then able to use the Scenario Modeling Screen 62 shown in FIG. 9. The Scenario Modeling Screen contains seven areas: database set-up, scenario development, group scenario definition, client scenario definition, analysis summary display, report display selector, and deployment matrix analysis display.

Database set-up is a menuing system that accesses space types, telework configuration profile, continuity configuration, and travel demand management technique set-up screens.

Scenario development is a menuing system that allows the individual scenario types to be defined.

Group scenario definition is a selection system that allows mixing and matching of the various scenarios amongst the six scenario types for evaluation and adoption of a group scenario.

Client scenario definition is a system, which allows client scenarios to be defined by selecting a specific group master for each group to create a client master for organization-wide analysis.

Analysis summary display is a system that displays critical data for the selected scenario set. This allows the user to determine quickly whether the scenario set has accomplished the goal.

Report display selector is a system, which displays comprehensive reports on every aspect of the TDP process.

Deployment matrix analysis display is a dynamic display that allows the user to correlate any two variables for the currently selected scenario set. The variables include hierarchy, technology level, days per week, and worker typology.

The Scenario Modeling Screen allows the users to analyze various combinations of scenarios until the business objective has been achieved. For example, if the goal is to avoid leasing additional space, the deployment would have to permit all growth to occur via telework. This scenario set is then saved as the Group Master Scenario.

By evaluating various combinations from the group master scenarios, the optimum plan is defined and it becomes the Client Master Scenario 74, which is then documented and forwarded to the executive team for further adjustments.

### Policy Review and Development

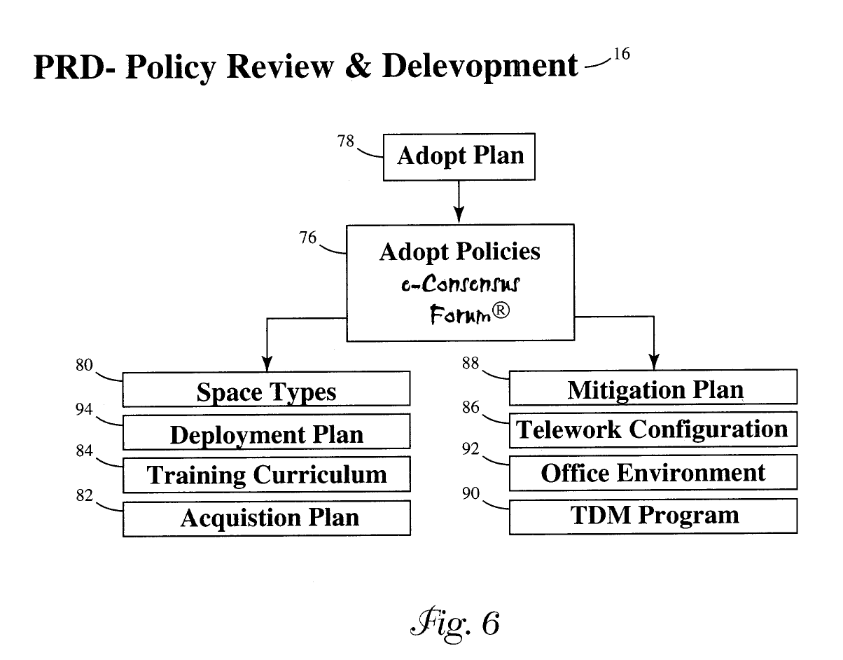

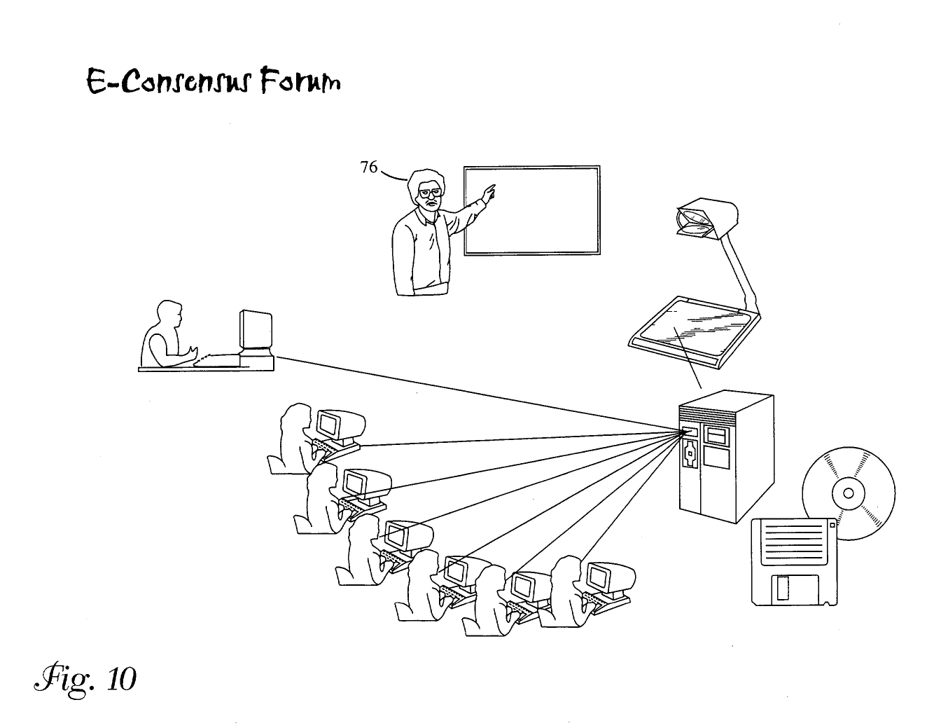

The Policy Review and Development phase 16 is shown in FIG. 6. When the Client Master Scenario is identified, the executive team is brought into the process via the e-Consensus Forum® 76, which is shown in FIG. 10. This policy development environment allows each participant the ability to comment on every issue anonymously, thereby allowing hidden agendas to be revealed. Through the various tools within this environment, the client examines the various impacts of the Client Master Scenario and reaches consensus. Similarly, by incorporating the capabilities of the Scenario Modeling Screen into the process, managerial support is quickly captured.

The e-Consensus Forum® 76 facilitates an executive review of the economic, cultural, and operational impacts of the deployment and, using a TDP policy checklist, allows a careful examination of existing policies that must be modified and new policies that must be adopted.

Following the executive review, a deployment plan 78 is adopted, which includes defining roles and responsibilities to accomplish the deployment in accordance with the adopted time-line and defining the implementation standards that will drive the plan.

Among the implementation standards are the following: a housing plan 80, an acquisition plan 82, a training plan 84, a telework configuration plan 86, a mitigation plan 88, a travel demand management plan TDM 90, and a telework home-site plan 92. The housing plan includes a conversion schedule, workspace specifications, and space use ratios. The acquisition plan includes plans for the acquisition of products and services. The training plan includes plans for instructors, syllabus, and course requirements. The travel demand management plan includes a promotion plan and a deployment schedule. The telework home-site plan includes a safety plan, a delivery schedule, security arrangements, formal and informal communications provisions, office recall parameters, and work and family equipment use and job flexibility code.

### Telework Implementation Plan

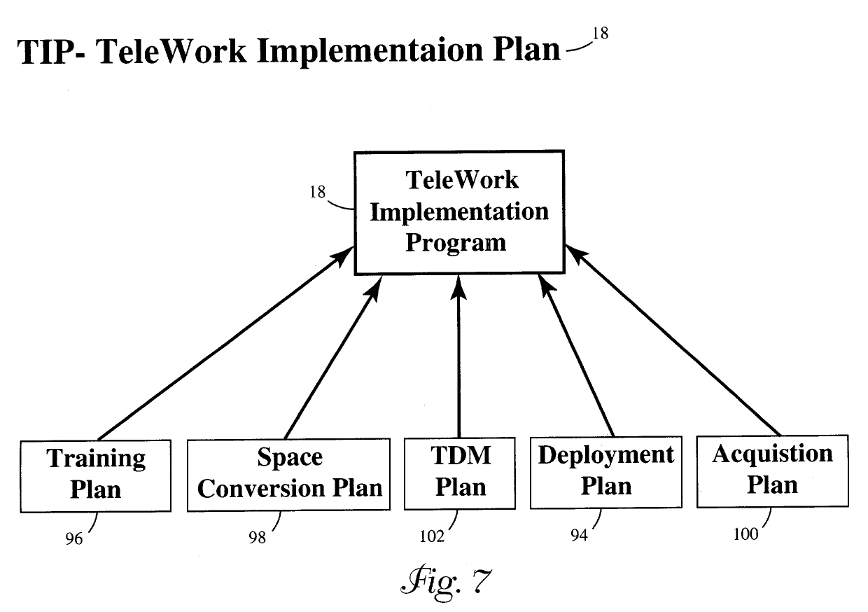

The Telework Implementation Plan phase 18 is shown in FIG. 7. With the employer's policies aligned with the Client Master Scenario, the client user develops coordinated plans for deployment, training, space conversion, products and services acquisition, and travel demand management.

The deployment plan 94, which establishes the timeline for implementation, will be adopted only after there is a consensus among all department heads. Once the time-line has been adopted, it is promulgated to all departments for implementation. Based upon the standards and policies defined in the Policy Review and Development phase 16, the deployment plan defines the schedule for the deployment of each job class, specifying the number of individuals to be deployed. Those selected for deployment are assessed for individual compatibility with deployment, as are their supervisors. Employees' personal characteristics, home environment, and work habits are evaluated. Supervisors are evaluated to ensure that they understand the work relationship being established and to guard against their penalizing the teleworkers they supervise.

The training plan 96 builds upon the findings of the managerial audit 26 as well as the requirements of inaugurating independent workers. The plan consists of developing a profile of courses to be taken by workers in each telework configuration and scheduling those courses. Facilities and instructors are part of the training database.

The space conversion plan 98 addresses a critical element in the program, which is the ability to recapture space that is no longer required for regular operations. Working in concert with the deployment plan, workers are identified for telework or relocation so that space can be renovated or downsized as the deployment builds. A system of area definitions and compatibility codes are used to assign the number of work spaces to various facilities and dynamically to coordinate this with the number of workers that will be using them.

The acquisition plan 100 is directed to equipment needs. Using purchase and transfer codes, the purchasing department will determine what equipment can be purchased outright and what equipment can be returned, refurbished, and reassigned. Based upon the deployment schedule and the telework configuration, quarterly acquisitions should be straightforward.

The travel demand management plan TDM 102 is concerned with maintaining relationships with the travel demand management agencies, which is critical to taking advantage of funding programs that will provide incentives for increasing commuting alternatives.

With all the departments coordinated around the deployment time-line, the program begins. As the various activities are completed, the files are updated and a Gantt Chart interface is used so that the program manager can monitor the overall project.

### Monitoring and Refinement

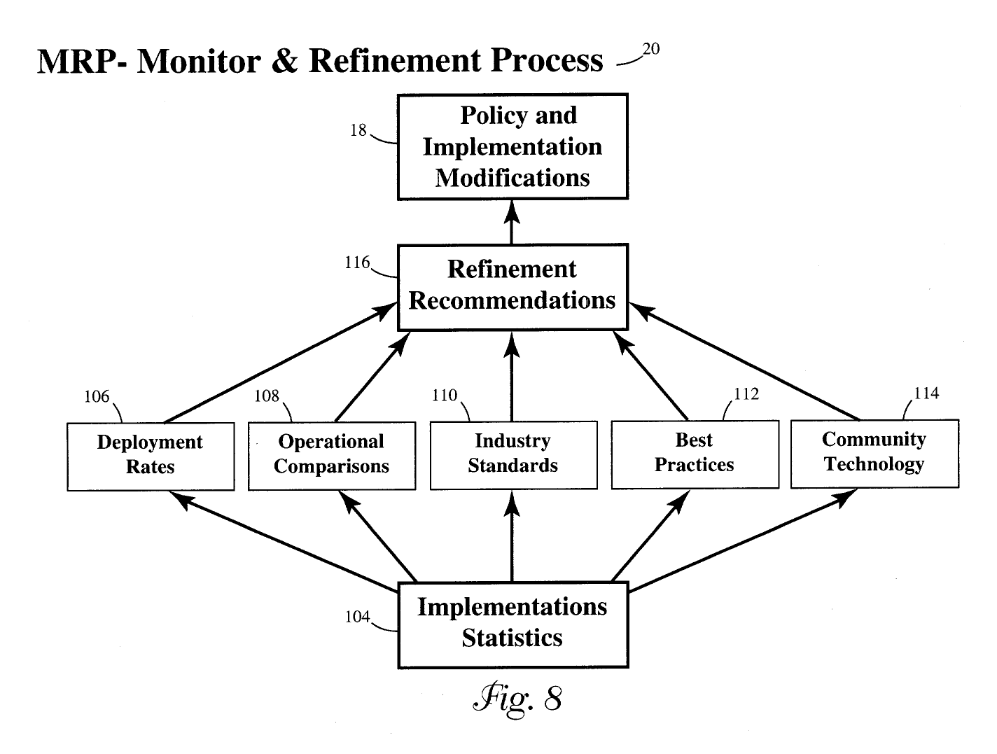

The Monitoring and Refinement Process phase 20 is shown in FIG. 8. Annually, each department updates the system relative to their compliance with the deployment plan. This update includes a Community Green Report, an Operational Performance Report, and a Comparative Analysis Report. The Community Green Report profiles the travel demand management techniques used and documents the number of trips saved, emissions reductions, accident and injury reductions, and employee time and resource savings. The Operational Performance Report reviews deployment standards and plan to actual statistics. The Comparative Analysis Report compares results with those of other industries and other communities.

Referring to FIG. 8, implementations statistics 104 are analyzed with respect to deployment rates 106, operational comparisons 108, industry standards 110, best practices 112, and community technology 114 to provide a series of refinement recommendations 116, leading to a set of projected policy and implementation modifications 118.

### RTAP

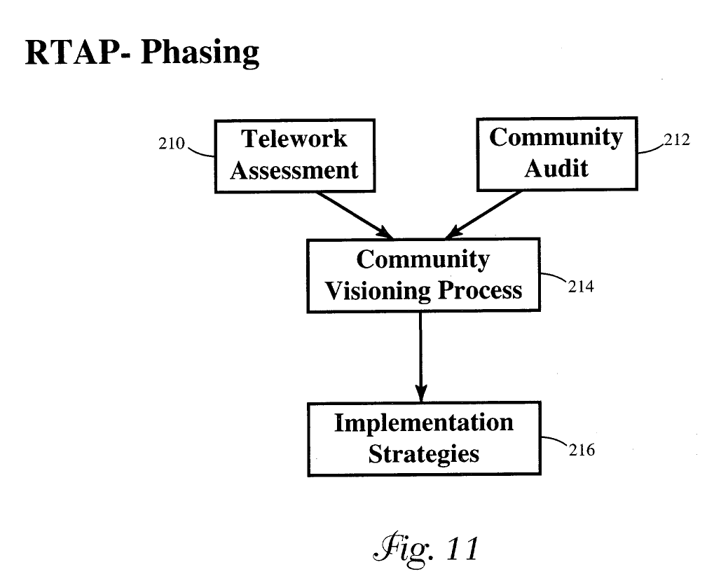

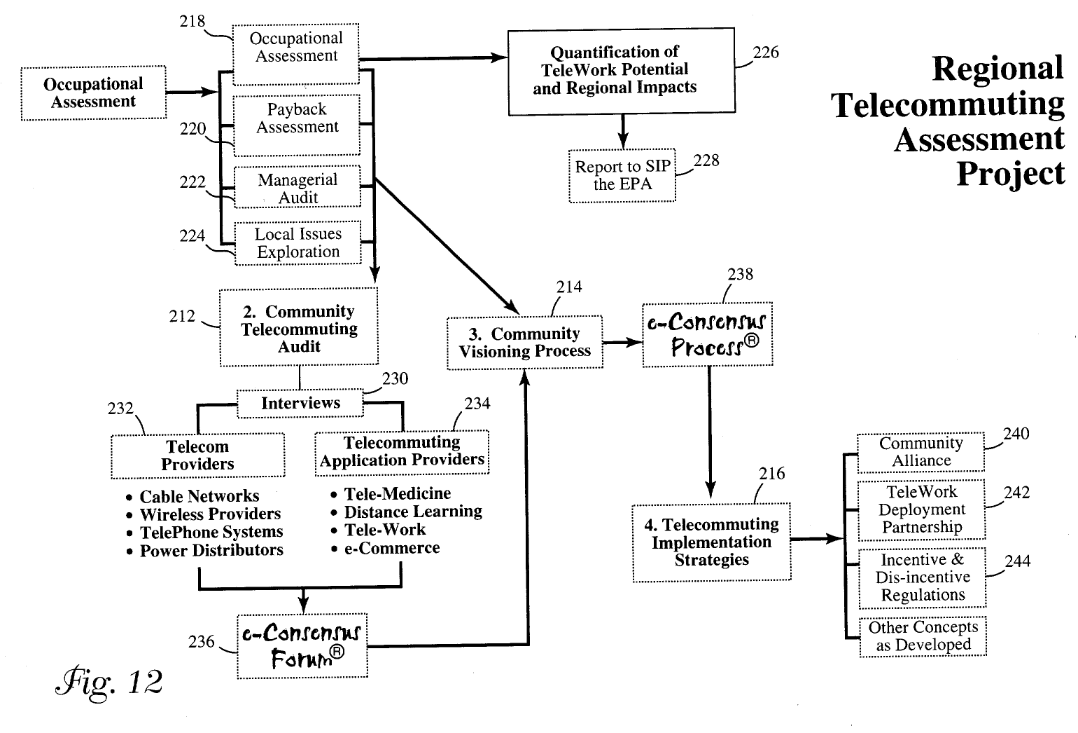

The Regional Telecommuting Assessment Project (RTAP) is shown in FIGS. 11 and 12. The RTAP consists of the following phases:

1. telework assessment;

2. community telecommuting audit;

3. community visioning process; and

4. telecommuting implementation strategies.

The RTAP establishes a telework goal as a means of mitigating traffic congestion.

### Telework Assessment

The Telework Assessment 210 shown in FIG. 12 evaluates the potential of each occupation existent within a Metropolitan Service Area (MSA) using a job class audit 218, a personal preference survey 220, a managerial audit 222, and local issues exploration 224 to quantify the potential and impact 226 for telework in the MSA and to provide a report 228 to the EPA. It also calculates the amount of time that could be saved by eliminating a commute to work via telework as well as the costs of that commute and the amount of pollution that would be eliminated and the number and cost of the accidents and injuries prevented. Conducted over the Internet via a system provider's website, the occupations are identified using an encoder which determines which of the Standard Occupational Classification (SOC) codes are to be assessed and an industrial matrix which assigns these occupations proportionately to their industry group.

In addition to the occupational assessment defined above, there is a concurrent distribution of the Telework Deployment Program (TDP) to employers within select industries. When these companies have adopted their deployment plans, they will be analyzed and a projection of a regional deployment target is then determined.

### Community Telecommuting Audit

The Community Telecommuting Audit 212 consists of one-on-one interviews 230 with the leaders of the various telecommuting applications (Tele-medicine, e-Commerce, e-Learning, etc.) including telecom providers 232 and telecommuting application providers 234 to determine the scope of their technology requirements, delivery strategy and time-line. Each of these groups is convened separately using an e-Consensus Forum® series to determine their perspectives on problems and opportunities. A third forum is held with representatives of the two groups to determine the feasibility of creating a “Bandwidth Collaborative”. If formed, this group would market specific telecommuting applications with the goal of lowering costs and expanding use of both the infrastructure and the specific application. A nine-week e-Consensus Forum® 236 is then initiated to begin an electronic dialogue that would build a consensus about telework and what its potential impacts would be in the years ahead. Participation would be open to the entire community.

An optional nine week e-Consensus Forum® would be conducted with community organizations to provide additional perspective on the importance of the initiative.

### Community Visioning Process

The Community Visioning Process 214 convenes a group of community leaders together with all of the data collected thus far via a second e-Consensus Forum® series 238 conducted on-site with the goal of adopting a set of principles for community development and determining the role of telecommuting for the MSA. Specific recommendations for implementation of the various telecommuting programs would be identified, evaluated and prioritized by this group.

### Telecommuting Implementation Strategies

The Telecommuting Implementation Strategies phase 216 determines the specific operational roles of the various entities involved in the RTAP. Specific implementation strategies are identified, prioritized and initiated. As part of that process several specific activities are evaluated.

Community Alliance 240 is a strategy to bring community groups together to leverage technologic investments so that they may operate in the virtual telecommuting world.

Telework Deployment Partnership 242 is an ongoing relationship that would allow the local partner to market the Telework Deployment Program (TDP).

Incentive/Dis-incentive Regulations 244 involves drafting materials for legislative consideration.

Other activities which are evaluated include zoning, comprehensive plan element, and urban design. Also included is a community telecenter network concept in which there are incorporated several levels of telecenters networked together to allow everyone, everywhere, cost effective access to the benefits of the telecommuting applications and the Community Alliance materials, providing guidance about how a community could incorporate telecommuting applications into a community's development plan and defining changes in community design if the telecommuting strategies were to be adopted.

### RTAP/TDP Web Interactivity

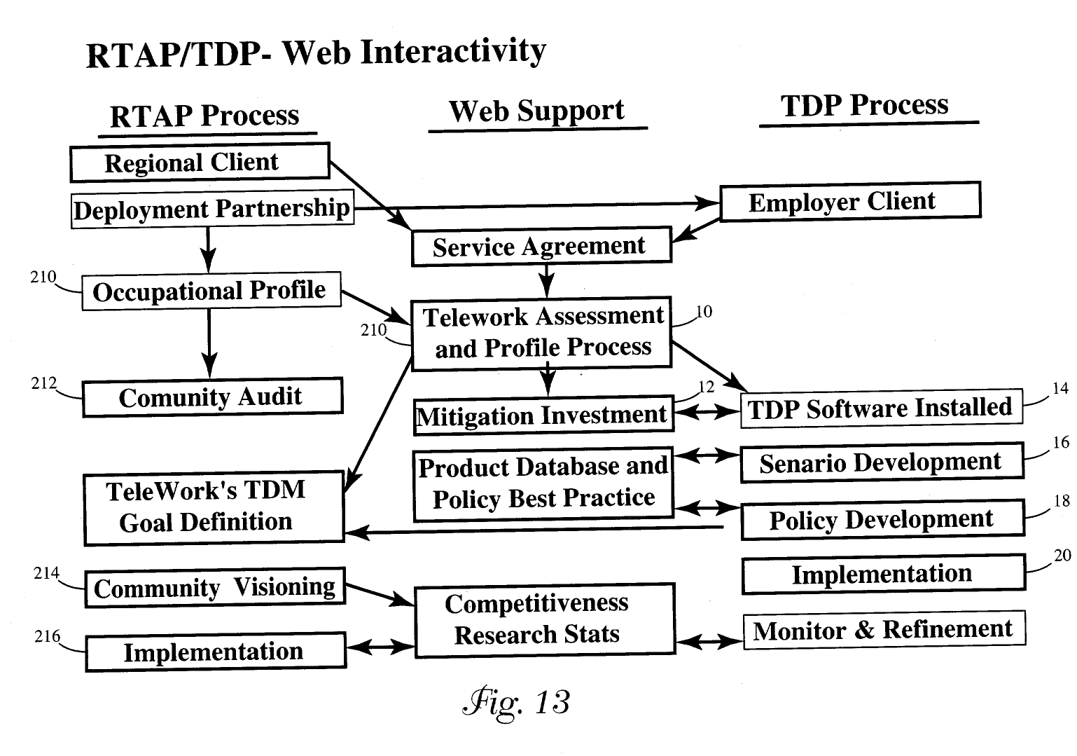

The interactivity of the system provider's website and the RTAP and TDP programs is shown diagrammatically in FIG. 13. The system provider's website is used to educate the public about telecommuting issues, promote the adoption of a “telecommuting mindset” and to support the delivery of system services. Typically a client, TDP or RTAP, would develop their service agreement over the web through a website such as www.telecommuting.org.

RTAP clients could optionally establish a Deployment Partnership with the system provider as part of the Occupational Assessment. Participating employers would access the website and register themselves and their employees under a modified TAPP program. Regular TDP clients would establish their agreement and execute the full TAPP program. These assessments are completed and reports delivered via the web.

TDP clients, upon reviewing their TAPP report, would decide to continue with the Mitigation Investment Analysis or end their involvement. Having installed the TDP software, the clients would investigate mitigations to the barriers that were identified by TAPP. The website provides the data for this analysis, the results of which are then downloaded to their software.

The website also provides support databases containing product and service information that can be downloaded as part of the Scenario Development process for both the telework and continuity configuration definitions. Similarly, the Best Practices database can be accessed on the website during the policy development phase. RTAP regions establish a TDM database on the website for TDP downloading.

The TDP clients adopt their deployment plan as part of their policy development phase. This information is fed back to the RTAP process for analysis as part of the regional telework goal setting effort. Together with the Occupational Assessment data and the Community Audit results, this information is introduced to the Community Visioning Process supported by the e-Consensus Forum® on the system provider's website.

Both the RTAP and TDP clients have access to select views of the Competitiveness Research Statistics maintained on the system provider's website.

It will be appreciated that the disclosure and description in the instant specification are set forth by way of illustration and not limitation, and that various modifications and changes may be made without departing from the spirit and scope of the present invention.

What is claimed is:

1. A method for establishing a telework deployment program, which comprises:
(A) Assessing and profiling the feasibility of adopting a telework strategy;
(B) Implementing mitigation of the results of said assessing and profiling;
(C) Developing a scenario based upon the mitigated assessing and profiling;
(D) Subjecting said scenario to policy review and development;
(E) Implementing a telework deployment program based upon the policy reviewed and developed scenario; and,
(F) Monitoring and refining said telework deployment program.

2. A method for the strategic implementation of a telework deployment program, which comprises:
(A) Instituting a telework feasibility assessment process including the steps of:
1.) Conducting a job class audit;
2.) Identifying barriers to the effective utilization of a telework program; and,
3.) Conducting a managerial audit.
(B) Utilizing the results of the telework feasibility assessment process to perform an investment analysis; and,
(C) Formulating a report recommending a master scenario for implementing a telework deployment program based upon said feasibility assessment process and said investment analysis.

3. A method according to claim 2, further comprising the step of conducting a policy review of said master scenario.

4. A method according to claim 3, further comprising implementing a telework deployment program based on said policy review.

5. A method according to claim 4, further comprising monitoring said telework deployment program.

6. A method according to claim 3, wherein said policy review is conducted by means of an c-Consensus Forum®.

7. A system for establishing a telework deployment program, which comprises:
(A) Means for assessing and profiling the feasibility of adopting a telework strategy;
(B) Means for implementing mitigation of the results of said assessing and profiling;
(C) Means for developing a scenario based upon the mitigated assessing and profiling;
(D) Means for subjecting said scenario to policy review and development;
(E) Means for implementing a telework deployment program based upon the policy reviewed and developed scenario; and,
(F) Means for monitoring and refining said telework deployment program.

8. A system for the strategic implementation of a telework deployment program, which comprises:
(A) Means for conducting a job-class audit;
(B) Means for identifying barriers to the effective utilization of a telework program;
(C) Means for conducting a managerial audit;
(D) Means for performing an investment analysis based upon said job-class audit, the identified barriers, and said managerial audit; and
(E) Means for producing a report recommending a master scenario for implementing a telework deployment program based upon said investment analysis, said managerial audit, said identified barriers, and said job-class audit.

9. A system according to claim 8, further comprising means for conducting a policy review of said master scenario.

10. A system according to claim 9, further comprising means for implementing a telework deployment program based on said policy review.

11. A system according to claim 10, further comprising means for monitoring said telework deployment program.

12. A system according to claim 9, wherein said means for conducting a policy review comprises e-Consensus Forum® means.

13. A system according to claim 7, wherein at least some of said means are provided by a website.

14. A system according to claim 8, wherein at least some of said means are provided by a website.

15. A method for establishing a regional telecommuting assessment project which comprises:
(A) Determining the potential for telework of each occupation existent within a metropolitan service area;
(B) Assessing the technology requirements, delivery strategy, and time line for implementation of a telework program within said metropolitan service area;
(C) Recommending implementation of said telework program; and,
(D) Evaluating specific activities required for said implementation.

16. A system for establishing a regional telecommuting assessment project which comprises:
(A) Means for determining the potential for telework of each occupation existent within a metropolitan service area;
(B) Means for assessing the technology requirements, delivery strategy, and time-line for implementation of a telework program within said metropolitan service area;
(C) Means for recommending implementation of said telework program; and
(D) Means for evaluating specific activities required for said implementation.

17. A system according to claim 16, wherein at least some of said means are provided by a website.

18. A method for the strategic implementation of a telecommuting assessment project, in a metropolitan service area, which comprises the steps of:
(A) A telework assessment;
(B) A community telecommuting audit;
(C) A community visioning process; and
(D) Telecommuting implementation strategies.

19. A system for the strategic implementation of a telecommuting assessment project in a metropolitan service area which comprises:
(A) Means for conducting a telework assessment;
(B) Means for performing a community telecommuting audit;
(C) Means for utilizing a community visioning process; and
(D) Means for implementing telecommuting strategies.

20. A system according to claim 19, wherein at least some of said means are provided by a website.
